(19) United States
(12) Patent Application Publication
(10) Pub. No.: US 2025/0078177 A1
(43) Pub. Date: Mar. 6, 2025

(54) Welding System Real-Time and Automated Quality Management System

(71) Applicant: Richard Mitchell, Harvest, AL (US)

(72) Inventor: Richard Mitchell, Harvest, AL (US)

(21) Appl. No.: 18/822,569

(22) Filed: Sep. 3, 2024

Related U.S. Application Data
(60) Provisional application No. 63/580,478, filed on Sep. 5, 2023.

(51) Int. Cl. G06Q 50/04; B23K 31/12; G06Q 10/0639

(52) U.S. Cl. CPC G06Q 50/04; G06Q 10/0639; B23K 31/125

(57) ABSTRACT

A data collection and management system designed for real-time monitoring of welding systems in refinery and petrochemical environments is disclosed. The system includes a data collection module integrated with sensors to automatically capture data from welding equipment (i.e., welder) using multiple protocols such as IoT and OPC. A database management module stores the data in a structured SQL database with indexing and search capabilities. A barcode generation and scanning module allows for quick data retrieval and updates by generating unique barcodes for welded components and documents. An AI module tracks equipment usage, efficiency, and downtime, predicting future maintenance needs and generating audit trails. A reporting module provides real-time visualization through interactive dashboards and generates automated reports for compliance and performance reviews. In one embodiment, a method enables efficient project management by comparing real-time equipment usage with predefined requirements and generating notifications for deviations.

### CROSS-REFERENCE TO RELATED APPLICATION

The present application claims priority to, and the benefit of, U.S. Provisional Application No. 63/580,478, which was filed on Sep. 5, 2023 and is incorporated herein by reference in its entirety.

### FIELD OF THE INVENTION

The present invention generally relates to the field of welding systems. More specifically, the present invention relates to a novel system which provides a real time, automated data collection of welding systems in refinery and petrochemical environments. The system includes a data collection module, a database management module, a database, a reporting module, and a software application. The system streamlines the data collection, management, and visualization processes for welding systems. Accordingly, the present disclosure makes specific reference thereto. Nonetheless, it is to be appreciated that aspects of the present invention are also equally applicable to other like applications, devices, and methods of manufacture.

### BACKGROUND

By way of background, welding is a fundamental process in various industrial projects, particularly in the refinery, petrochemical, construction, and manufacturing sectors. In refinery and petrochemical environments, welding is essential for constructing and maintaining pipelines, storage tanks, and processing equipment. Further, real-time data collection of welding systems in refinery and petrochemical environments is critical for maintaining operational efficiency, ensuring compliance, and producing reliable project documentation. In such industries, welding processes must adhere to stringent quality and safety standards. However, achieving desired efficiency and standards of welding are difficult. Welders cannot continuously maintain consistent quality and adherence to industry codes and standards. This can lead to substandard welds, compromising the integrity and safety of the welding systems. Real time monitoring of welding equipment and welders is desired.

Project contracts often stipulate the requirement to produce detailed turnover packages for clients upon project completion which documentation of the welding processes, inspections, and quality assurance measures. However, current processes fail to produce accurate and complete turnover packages can lead to contractual disputes and client dissatisfaction. Maintaining detailed historical data for each project is essential for tracing issues, conducting maintenance, and improving future projects. However, current systems collect inadequate data. There is a requirement for an improved system that can overcome the problems of the prior art.

Therefore, there exists a long felt need in the art for a welding system real-time monitoring system. There is also a long felt need in the art for an innovative system that offers real time, automated data collection of welding systems in refinery and petrochemical environments. Additionally, there is a long felt need in the art for a data management system that ensures that all welding data is accurately captured, stored, and analyzed. Moreover, there is a long felt need in the art for a system and application that facilitate the creation of detailed client turnover packages for welding projects. Further, there is a long felt need in the art for a software application that enhances the welding industry in all markets by saving considerable time and effort when exporting and presenting data in real time. Finally, there is a long felt need in the art for a QMS automation system designed to streamline the data collection, management, and visualization processes for welding systems in refinery and petrochemical environments.

The subject matter disclosed and claimed herein, in one embodiment thereof, comprises a data collection and management system for real-time data collection and management of welding systems in refinery and petrochemical environments. The system includes a server system which has a data collection module adapted to automatically collect data from welding systems, a database management module is adapted to store all data collected by the data collection module in a structured SQL database, wherein the database management module formats and structures the data for storage, and the database includes data indexing and search capabilities. A barcode generation and scanning module is adapted to generate unique barcodes for each welded component and associated documents, wherein the barcode generation and scanning module logs and tracks barcode scanning and usage, and the information is stored in the SQL database. A reporting module is adapted to create real-time and interactive dashboards and reports for visualization of welding systems data, wherein the reporting module generates automated reports for audits, compliance, and performance reviews. A software application is configured to display real-time dashboards and creation of detailed client turnover packages.

In this manner, the data collection and management system of the present invention accomplishes all of the forgoing objectives and provides users with a novel system that offers real time, automated data collection of welding systems in refinery and petrochemical environments. The system automatically captures different parameters of welding equipment and welders and saves considerable time and effort when exporting and presenting data in real time. The system streamlines the data collection, management, and visualization processes for welding systems in refinery and petrochemical environments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a data collection and management system for real-time data collection and management of welding systems in refinery and petrochemical environments. The system includes a data collection module adapted to automatically collect data from welding systems, a database management module is adapted to store all data collected by the data collection module in a structured SQL database, wherein the database management module formats and structures the data for storage, and the database includes data indexing and search capabilities. A barcode generation and scanning module is adapted to generate unique barcodes for each welded component and associated documents, wherein the barcode generation and scanning module logs and tracks barcode scanning and usage, and the information is stored in the SQL database. A reporting module is adapted to create real-time and interactive dashboards and reports for visualization of welding systems data, wherein the reporting module generates automated reports for audits, compliance, and performance reviews.

In yet another embodiment, the system includes an AI module configured to track usage, efficiency, and downtime of welding equipment (i.e., welder), wherein the AI module determines future efficiency and maintenance needs and creates audit trails for welding equipment and welders.

In another embodiment, a method for real-time data collection and management of welding systems in refinery and petrochemical environments is disclosed. The method includes initializing data collection from welding equipment (i.e., welder) using a data collection module integrated with a plurality of sensors, scanning barcodes associated with welding equipment (i.e., welder) to capture information, wherein the barcodes include physical information and unique identifiers of welding equipment (i.e., welder), formatting and processing the collected data as per the schema of a SQL database and storing the data in the database, wherein the data includes timestamps for monitoring, and visualizing real-time data through dashboards and generating periodic and automated reports for review.

In another aspect, a method for determining welding project efficiency using a data collection and management system is described. The method includes the steps of inputting welding project requirements into the system via an interface, including details of welding equipment (i.e., welder), allocated time, and raw materials, collecting real-time data from the welding equipment (i.e., welder), and storing it in a SQL database, comparing the usage of welding equipment (i.e., welder) with the project requirements, and generating automatic reports and notifications if the usage deviates from the project requirements beyond a predetermined threshold.

In yet another aspect, the data collection module is configured to support additional data collection protocols including Modbus and the reporting module includes predefined and customizable dashboard templates for generating reports.

In still another embodiment, the method includes flagging anomalies and maintenance needs detected during data processing, and storing this information in the SQL database for subsequent analysis

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of real-time welding systems data collection and management system of the present invention in accordance with the disclosed structure;

FIG. 2 illustrates a flow diagram depicting a workflow of the welding systems data collection and management system in accordance with one embodiment of the present invention; and

FIG. 3 illustrates a flow diagram depicting a process of determining welding project efficiency by the system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a welding system real-time monitoring system. There is also a long felt need in the art for an innovative system that offers real time, automated data collection of welding systems in refinery and petrochemical environments. Additionally, there is a long felt need in the art for a data management system that ensures that all welding data is accurately captured, stored, and analyzed. Moreover, there is a long felt need in the art for a system and application that facilitate the creation of detailed client turnover packages for welding projects. Further, there is a long felt need in the art for a software application that enhances the welding industry in all markets by saving considerable time and effort when exporting and presenting data in real time. Finally, there is a long felt need in the art for a QMS automation system designed to streamline the data collection, management, and visualization processes for welding systems in refinery and petrochemical environments.

The present invention, in one exemplary embodiment, is a method for determining welding project efficiency using a data collection and management system. The method includes the steps of inputting welding project requirements into the system via an interface, including details of welding equipment (i.e., welder), allocated time, and raw materials, collecting real-time data from the welding equipment (i.e., welder), and storing it in a SQL database, comparing the usage of welding equipment (i.e., welder) with the project requirements, and generating automatic reports and notifications if the usage deviates from the project requirements beyond a predetermined threshold. The method includes monitoring welder data and comparing to predetermined thresholds to measure performance and qualifications of the welders.

Reference will now be made in detail to the present preferred embodiments of the invention, examples of which are illustrated in the accompanying drawings. Wherever possible, the same reference numerals are used in the drawings and the description to refer to the same or like parts.

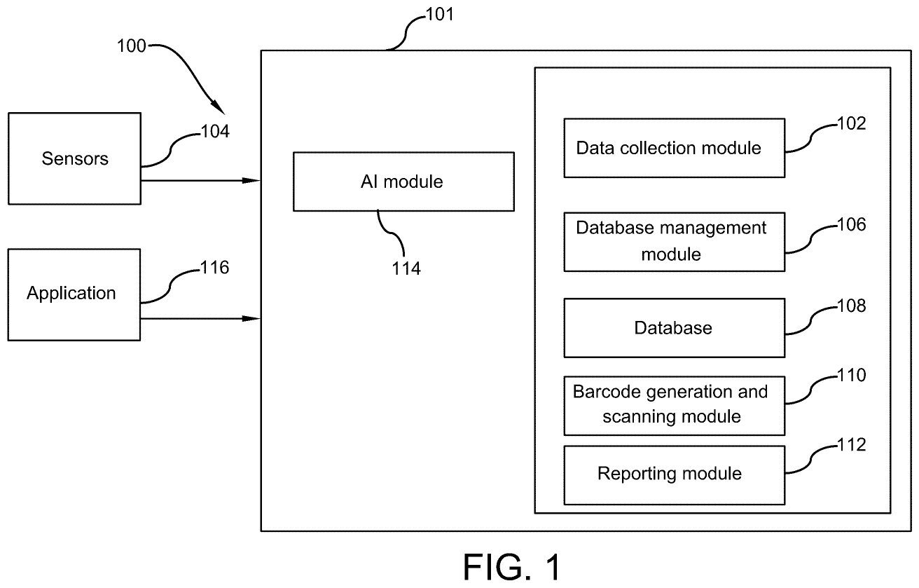

Referring initially to the drawings, FIG. 1 illustrates a schematic view of real-time welding systems data collection and management system of the present invention in accordance with the disclosed structure. The data collection and management system 100 of the present invention is designed for real-time data collection and management of welding systems in refinery and petrochemical environments. More specifically, the quality management system for welding systems 100 is adapted to automate the collection of data from welding systems to streamline the data collection, management, and visualization processes for welding systems. The system 100 includes a server system 101 which includes a data collection module 102 adapted to automatically collect data from welding systems and related equipment. In preferred embodiment, the data collection module 102 integrates with a plurality of sensors 104 disposed on the welding systems. The data collection module 102 performs accurate and timely data capture without manual intervention (i.e., autonomously) and can support different data collection protocols such as IoT communication protocols, OPC, and more. The data collection module 102 can be a central module or there can be a plurality of modules 102 for collecting data from different welding systems.

A database management module 106 is adapted to store all data collected by the data collection module 102 in a 108 such as structured SQL database. The database management module 106 formats and structures the data for storage in the SQL database 108. The database 108 includes a schema designed for welding data and includes data indexing and search capabilities. The database 108 allows an operator to run easy data retrieval queries to retrieve the data from the database 108. The database format used in the present invention can include but not limited to an Oracle database format, an IBM DB2 database format, a Microsoft SQL database format, a MySQL database format, a NoSQL database format, and a NewSQL database format.

A barcode generation and scanning module 110 is adapted to generate unique barcodes for each welded component. The barcode can also be associated to a document related to the welded component. The barcode used in the quality management system for welding systems 100 helps in scanning thereof to quickly retrieve or update data in the SQL database 108. The barcodes can be read by conventional barcode readers and scanners. The data collection module 102 is adapted to log and track barcode scanning and usage and the information is stored in the database 108.

A reporting module 112 is adapted to create real-time and interactive dashboards and reports for real-time visualization of welding systems data for monitoring and decision making. The reporting module 112 is also configured to generate automated reports for audits, compliance, and performance reviews. The reporting module 112 is directly coupled to the database 108 for retrieving data and can include predefined and customizable dashboard templates for creating reports.

An AI module 114 included in the system 100 is configured to track data such as usage, efficiency, downtime, and more of each welding equipment (i.e., welder). The data is used for determining the future efficiency and maintenance needs of the welding equipment (i.e., welder). Audit trail of each welding equipment and welder is created and is used for determining anomalies like welder efficiency, spot welds, and more. A software application 116 or alternatively can be a website is used for displaying the dashboards and exporting reports for producing detailed turnover packages. Notifications and mitigation plans are also displayed on the software application. In some embodiments, the reporting module 112 can be integrated in the software application 116 and AI module 114 is directly coupled to the software application 116.

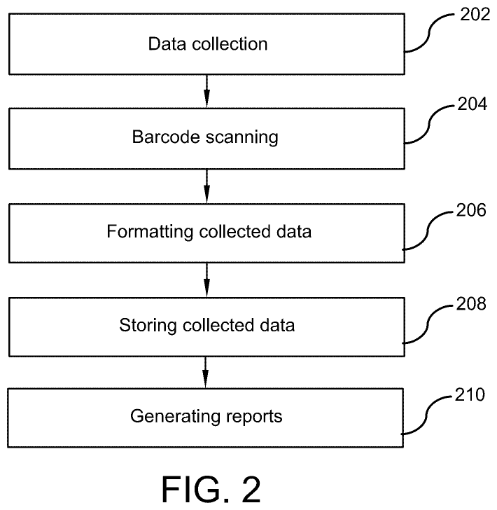

FIG. 2 illustrates a flow diagram depicting a workflow of the welding systems data collection and management system in accordance with one embodiment of the present invention. Initially, the data collection module 102 initializes the data collection from the coupled welding equipment (i.e., welder) and welding devices (Step 202). The module 102 can be in the form of hardware, software, or firmware. Then, one or more barcodes of the welding equipment (i.e., welder) are scanned using a reader to read or capture the information of the welding equipment (i.e., welder) (Step 204). The barcode can include physical information such as name, location, dimensions, and a unique identifier for identification of the equipment in the system 100.

The collected data is formatted as per schema of the database 108 and is processed from the received protocol (Step 206). The module 106 is also configured to detect and flag any anomalies and maintenance needs in the welding system. The formatted data is stored in the database wherein the data of each equipment is uniquely identified by identifier of the equipment (Step 208). The information is tagged with a timestamp for monitoring the welding system. Finally, the real-time data is visualized in the form of dashboards and periodic and predetermined reports are automatically generated and exported for review by operators (Step 210).

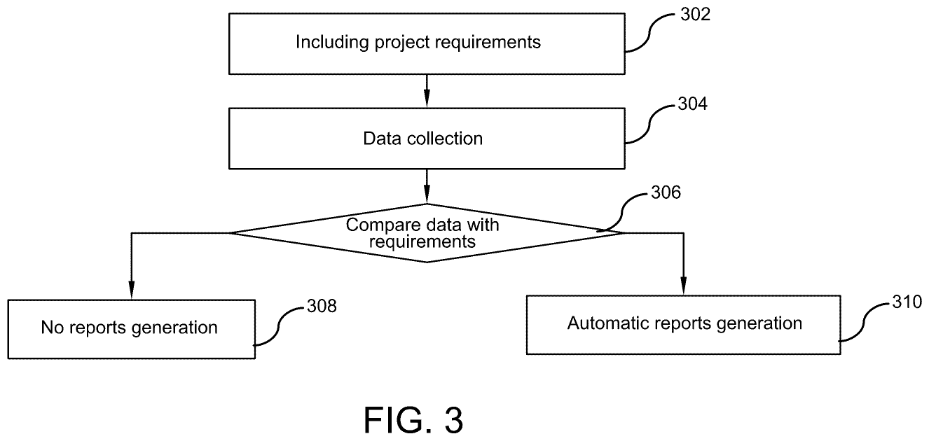

FIG. 3 illustrates a flow diagram depicting a process of determining welding project efficiency by the system of the present invention in accordance with the disclosed architecture. Initially, welding project requirements are included in the system 100 using an interface provided by the system (Step 302). The requirements can be details of different welding equipment (i.e., welder) required, allocated time, raw materials, and more. Then, the welding equipment data is collected in real-time by the collection module 102 and is stored in the database as described earlier in the disclosure (Step 304). Then, the usage of different welding equipment (i.e., welder) is compared with the project requirements (Step 306). In case the usage is within the project requirements and up to a predetermined deviation such as 10%, then, no automatic reports and notifications are generated (Step 308). When, the usage of the welding equipment (i.e., welder) does not match with the project requirements beyond the predetermined deviation, then, automatic reports and notifications are generated (Step 310).

The system 100 may include sensors which are disposed on the clothing of the welders during worktime. In some embodiments, the sensors can be wearable sensors. The system 100 is also configured to monitor efficiency of welders. In some embodiments, the anomalies of a welding task are correlated with the welder data and are used for determining qualifications of the welder. The efficiency of welders can be compared to predetermined thresholds to determine efficiency and qualifications of the welders.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “quality management system for welding systems”, “real-time welding systems data collection and management system”, “data collection and management system”, and “system” are interchangeable and refer to the real-time quality management system for welding systems 100 of the present invention.

Notwithstanding the forgoing, the real-time quality management system for welding systems 100 of the present invention can be of any suitable size and configuration as is known in the art without affecting the overall concept of the invention, provided that it accomplishes the above stated objectives. One of ordinary skill in the art will appreciate that the real-time quality management system for welding systems 100 as shown in the FIGS. are for illustrative purposes only, and that many other sizes and shapes of the real-time quality management system for welding systems 100 are well within the scope of the present disclosure. Although the dimensions of the real-time quality management system for welding systems 100 are important design parameters for user convenience, the real-time quality management system for welding systems 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A quality management system for welding systems comprising:
a welder;
a server system;
a data collection module;
a plurality of sensors;
a database management module;
a barcode; and
a welded component;
wherein said data collection module integrating with said plurality of sensors;
wherein said data collection module autonomously collecting welding data from said plurality of sensors;
wherein said data collection having a protocol selected from the group consisting of a IoT communication protocol and an OPC protocol;
wherein said database management module stores said data collection in a database;
wherein said database having said welding data; and
further wherein said barcode is associated to a document related to said welded component.

2. The quality management system for welding systems of claim 1, wherein said database having a format selected from the group consisting of an Oracle database format, an IBM DB2 database format, a Microsoft SQL database format, a MySQL database format, a NoSQL database format, and a NewSQL database format.

3. The quality management system for welding systems of claim 1 further comprising a barcode generation module for generating unique said barcode for each said welded component.

4. The quality management system for welding systems of claim 3 further comprising a first barcode reading module for reading unique said barcode for each said welded component.

5. The quality management system for welding systems of claim 4, wherein said barcode readable by a second barcode reading module.

6. The quality management system for welding systems of claim 4 further comprising a reporting module for creating real-time and interactive reports for real-time visualization of said welding data.

7. The quality management system for welding systems of claim 6, wherein said reporting module generating said real-time and interactive reports selected from the group consisting of an audit report, a compliance report, and a performance review report.

8. The quality management system for welding systems of claim 7, wherein said reporting module coupled to said database for retrieving said welding data.

9. The quality management system for welding systems of claim 6, wherein said reporting module generating said real-time and interactive reports selected from the group consisting of a usage report, an efficiency report, and a downtime report.

10. The quality management system welding systems of claim 9, wherein said efficiency report determining maintenance needs of said welder.

11. The quality management system welding systems of claim 10, wherein said efficiency report determining anomalies of said welder including a mitigation plan for said welder.

12. A quality management system for welding systems comprising:
a welder;
a server system;
a data collection module;
a plurality of sensors;
a database management module;
a barcode;
a welded component; and
a reporting module;
wherein said data collection module integrating with said plurality of sensors;
wherein said data collection module autonomously collecting welding data from said plurality of sensors;
wherein said database management module stores said data collection in a database;
wherein said database having said welding data;
wherein said reporting module for creating real-time and interactive reports for real-time visualization of said welding data; and
further wherein said reporting module generating said real-time and interactive reports selected from the group consisting of a usage report, an efficiency report, and a downtime report.

13. The quality management system for welding systems of claim 12 further comprising a barcode generation module for generating unique said barcode for each said welded component.

14. The quality management system for welding systems of claim 13 further comprising a first barcode reading module for reading unique said barcode for each said welded component.

15. The quality management system for welding systems of claim 14, wherein said reporting module generating said real-time and interactive reports selected from the group consisting of an audit report, a compliance report, and a performance review report.

16. The quality management system for welding systems of claim 15, wherein said reporting module coupled to said database for retrieving said welding data.

17. The quality management system welding systems of claim 12, wherein said efficiency report determining maintenance needs of said welder.

18. The quality management system welding systems of claim 12, wherein said efficiency report determining anomalies of said welder including a mitigation plan for said welder.

19. A method of determining welding project efficiency, the method comprising the steps of:
providing a welder, a server system, a data collection module, a plurality of sensors, a database management module, a barcode, a welded component, and a reporting module;
integrating said data collection module with said plurality of sensors;
autonomously collecting welding data with said data collection module and said plurality of sensors, wherein said database management module stores said data collection in a database, further wherein said database having said welding data; and
creating real-time and interactive reports from said reporting module for real-time visualization of said welding data, wherein said reporting module generating said real-time and interactive reports selected from the group consisting of a usage report, an efficiency report, and a downtime report.

20. The method of determining welding project efficiency of claim 19 further comprising a step of generating unique said barcode for each said welded component with a barcode generation module.
